(19) United States
(12) Patent Application Publication
(10) Pub. No.: US 2013/0013481 A1
(43) Pub. Date: Jan. 10, 2013

(54) Computerised Method and System for Trading Credit Default Swap Combinations

(75) Inventor: Steven Cooper, Rumson, NJ (US)

(73) Assignee: ICAP NORTH AMERICA INC.

(21) Appl. No.: 13/026,501

(22) Filed: Feb. 14, 2011

(51) Int. Cl. G06Q 40/00

(52) U.S. Cl. 705/37

(57) ABSTRACT

A computerised trading system comprises a multi-instrument trading platform including a matching engine and a price feed. The matching engine trades credit default swaps as well as the reference instruments from which they are derived. A price feed generates a spot reference price for a leg of a CDS combination such as a roll or a tailor made switch. The price feed receives indicative pricing data from an external pricing source and uses this data to generate the spot reference price together with last trade data and best bid and best offer data for the reference instrument provided by the matching engine.

### FIELD OF THE INVENTION

This invention relates to a system and computerised method for combination or linked trades of credit default swaps (CDS) and credit default swap indices (CDX), in particular switches and rolls.

### BACKGROUND TO THE INVENTION

Credit default swaps may be regarded as an insurance against credit risk. A CDS is a bilateral contract negotiated between two parties under which a party holding credit risk protects that risk from defined credit events by payment of a fixed fee to the provider of protection. The fee is paid at fixed intervals over the duration of protection. In the event of a credit event occurring before maturity of the contract, the provider of protection pays compensation to the buyer of protection.

A CDS protects against credit risk and a compensation payment may be triggered by one of a number of events such as bankruptcy of the reference entity; a failure to pay interest or principal amounts by the reference entity to the creditor; a restructuring of the reference entity or a number of other trigger events.

The premium paid by the protection buyer to the seller, referred to as the spread, is quoted in basis points (bps) per annum of the contract's notional value and is typically paid quarterly. CDS spreads are the annual price of protection quoted in bps. In the case of default, the amount insured is either delivered in full, or more likely, the amount delivered is the difference between the amount in full and its recovery value. If a credit event occurs, that delivery may be a physical or cash settlement, as specified in the contract. In a physical settlement the protection seller buys the loan or bond from the protection buyer at par, within a short term, typically 30 days, agreed in the contract. A cash settlement delivers the difference between the notional value and the recovery value. Cash settlement is less common due to the difficulty in obtaining a value for the distressed credit that can be accepted by both parties.

The pricing of a credit default swap depends on a number of factors including the likelihood of default, the recovery rate when default occurs and a discount which reflects market sentiment and liquidity of the reference entity. To price a credit default swap, assumptions must be made, or knowledge acquired, about the likelihood of default over the term of the swap, the recovery rate and discount factors. These factors make CDS particularly suited to negotiation as both buyer and seller are likely to have differing views as to the correct pricing structure.

Credit default swaps are attractive as they do not require any initial funding, thus allowing leveraged positions to be taken. Credit default swaps are traded extensively to allow investors to speculate on changes in CDS spreads of single names or of market indices such as the North American CDX or European iTraxx indices. Trades may be made for a variety of purposes including speculation, hedging and arbitrage. One aspect of CDS trading is the rolling of a contract over to new issues and the switching of maturity dates. Pricing of these rolls and switches requires an accurate value of the spot price of the underlying or reference instrument.

Over the past few decades, the financial markets have increasingly moved towards electronic trading platforms which permit very swift execution of trades while offering transparency and liquidity to markets. Electronic trading of relatively simple instruments such as foreign exchange spot has been conducted for over twenty years. However, more complex instruments such as CDS are less easy to trade electronically as their successful trading relies on the parties coming to agreement on the pricing of the instrument. Although CDS trading platforms exist they do not offer a clear solution for the trading of rolls and switches as they cannot provide reference data with sufficient reliability that it will be accepted by the market. Additionally, no standard has existed for consistently handling and calculating rolls and switches.

### SUMMARY OF THE INVENTION

The present invention aims to address this problem and to provide a system and method which allows electronic trading of credit default swap single names and credit default swap index combination instruments based on spot reference pricing data that is accepted by all market participants. Accordingly, the invention provides a computerised trading system for trading credit default swaps combinations, comprising: a matching engine storing data relating to credit default swaps available for trading and data relating to the reference instruments on which they are based; a price feed for generating a spot reference price for credit default swap combinations, the spot reference price being the spot reference price of one leg of the combination; wherein the price feed is operable to receive pricing data for generation of the spot reference price from a pricing source external to the computerised trading system and from the matching engine.

The invention also provides a computerised method for trading credit default swap combinations on a computerised trading system trading the reference instrument underlying the swap combination, the trading system comprising a matching engine and a price feed, wherein the method comprises: the price feed generating a spot reference price for the credit default swap combination, wherein the spot reference price is at least partially generated from a source of pricing of the reference instrument external to the trading system; and distributing the generated reference prices to trader terminals communicating with the trading system together with further data relating to the credit default swap combination.

The invention further provides a price feed for a computerised trading system for trading credit default swap combinations, the trading system having a matching engine for matching bids and offers to perform trades, the price feed being configured to receive indicative pricing data for a reference instrument of a leg of the combination from a pricing source external to the trading system, and to receive market data relating to the reference instrument from the matching engine including trade prices and best bid and best offer prices, and wherein the price feed is further configured to generate a reference price of a leg of the combination from the trade prices, the best bid and best offer prices and the external indicative prices.

In a preferred embodiment of the invention, the pricing data received from the matching engine is the last traded price of the reference instrument. The price feed may generate the spot reference price for the credit default swap combination from the last traded price of the reference instrument if the last trade in the reference instrument occurred within a predetermined period of time.

The pricing data received from the matching engine may include at least one of the current best bid and offer for the reference instrument. The pricing data received from the external pricing source may be indicative pricing data. In a preferred embodiment of the invention, the price feed generates the spot reference price from the pricing data received from the external pricing source if a best bid and best offer price are available from the matching engine and the best bid best offer spread is within a predetermined range. Preferably the price feed generates the spot reference price from the pricing data received from the external pricing source if only one of a best bid and best offer price is available from the matching engine and the best bid best bid or offer is within a predetermined distance of the price from the external pricing source. Preferably the price feed generates the spot reference price from the pricing data received from the external pricing source if the matching engine indicates that there are no orders in the market for the reference instrument.

Preferably, the price feed is configured to generate a reference spot price from the mid point of the best bid and best offer if the mid price is greater than a predetermined distance from the indicative price received from the external pricing source. In a one sided market, if only the best bid price is received by the price feed from the matching engine, the price feed is configured to generate the spot reference price from the best bid price minus a predetermined number of price ticks. If only the best offer price is received by the price feed from the matching engine, the price feed is configured to generate the spot reference price from the best offer price plus a predetermined number of price ticks.

In a preferred embodiment, the price feed is configured to send generated reference prices to the matching engine. A plurality of trader terminals are coupled to the trading system. Each trader display displays credit default swap combinations available for trading the display and includes the spot reference price for a leg of each combination generated by the price feed and broadcast to the trader terminals by the matching engine.

The credit default swap combinations may be rolls or switches and the credit default swaps may be single name instruments or index instruments.

Embodiments of the invention have the advantage that rolls and switches can be traded on a credit default swap trading system as a spot reference price can be shown to traders that can be relied on and agreed. This enables trading parties to enter into rolls and switches with confidence and so makes electronic trading of rolls and switches feasible which has not been possible in the past.

### DESCRIPTION OF DRAWINGS

Embodiments of the invention will now be described, by way of reference only, and with reference to the accompanying drawings, in which:

FIG. 1 is a highly schematic representation of a multi-instrument electronic trading system which enables the trading of credit default rolls and switches by providing reference prices for these rolls and switches.

FIG. 2 shows an indicative pricing window displayed in a price feed interface;

FIG. 3 is a portion of a screen shot showing indicative pricing for a particular CDX instrument;

FIG. 4 is a screen shot showing indicative pricing;

FIG. 5 shows an instrument series window that defines a switch of fix in a price feed;

FIG. 6A to 6C show the steps used to determine the spot price of an instrument;

FIG. 7 is a screen shot showing a spot pricing window in the price feed;

FIGS. 8A and 8B show a credit front end or trader display showing spot reference pricing for switches and rolls; and

FIG. 9 shows elements of the message flow between the matching engine, the price feed and the trader terminals.

In the credit default swaps market, every three months, single name credit default swaps roll as new 5 year CDS contracts are created. Index based CDS roll every six months. The older series indices continue to trade in the market creating an ongoing need to roll back and forth between new and old series. The term of a credit default swap may vary and the contract holder may wish to switch from one maturity date to another. Thus a roll is a continuation between two different series of CDS that have the same or different maturity dates, whereas a switch is a continuation between the same series of CDS but with different maturity dates. Both are examples of combination instruments A combination may be viewed as a simultaneous buy and sell of multilegged instruments traded on a relative basis to one another. Thus combinations are a type of linked order. Although the present invention is particularly relevant to rolls and switches in the credit default swaps market it is applicable to other markets, for example, but not limited to, agencies and corporates.

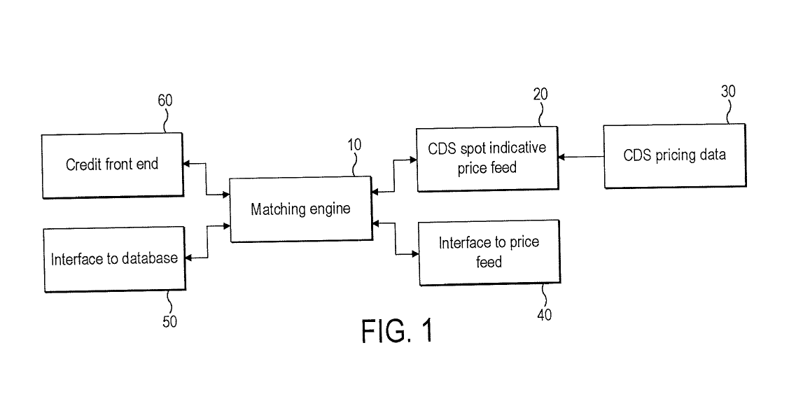

In FIG. 1, the basic architecture of a trading system is illustrated. A matching engine 10 is the heart of the CDS trading platform and matches bid and offers to perform trades with one price of the trade based on CDS spot and indicative pricing information received from a CDS price feed 20. The trading platform is a multi-instrument trading platform and, as well as trading credit default swap singles and index instruments, also trades the outright reference instruments on which the credit default swaps spot prices are based. The trading platform may be a known platform such as the assignee's BrokerTec® platform in which the matching engine is a conventional computer or cluster of computers having associated storage devices and which is programmed to carry out trading in response to bids and offers submitted by traders or brokers.

The price feed 20 generates spot reference prices based on priority based data from a number of sources as described below. One of those sources is a source of market data 30 that provides CDS indicative pricing. The price feed 20 retrieves prices from the market data source using instrument RED codes. RED codes link debt issuers to their obligations using Cusip-linked pair codes, or CLIPs which are unique identifiers. The first six characters of the nine character CLIP represents the reference entity and the last three represent the reference obligation.

A user interface to the price feed 40 is provided to enable monitoring and management of the price feed by a system administrator. The spot pricing data is also available via the trading system API

The matching engine 10 includes a database storing reference and configurations data required to trade CDS. An interface 50 to this database enables the administrator to set up reference instruments for CDS switches and rolls. A credit front end 60 displays spot prices for switches and rolls and uses the indicative price as a source for pre-populating a passive manager and calculating price deviations. The credit front end is displayed in a trader terminal. A plurality of trader terminals, which may be known PCs are connected to the trading system in known manner.

Indicative prices are used to pre-populate the passive manager and calculate price deviations in the credit front end for CDS instruments which may include single names, indices (CDX), rolls and tailor made switches. The indicative price is derived from the CDS pricing data 30 including live bids and/or offers in the market and from the last traded price for the instrument which is known from the matching engine 10 which may, for example, communicate pricing data to the credit front end via a broadcast message.

The indicative price is calculated for rolls and tailor made (TM) switches as follows:

Switches: the indicative price is the difference between the EOD (end of day) price of the longer term instrument and the EOD (end of day) price of the shorter term instrument. It may be expressed as the difference between the indicative price of the shorter instrument and that of the longer instrument depending on the switch being spread based or price based. By way of example, the IG index is spread based whereas the HY index is price based. Thus the IG switch is the longer minus the shorter and the HY switch is the shorter minus the longer.

Rolls: the indicative price is the difference between the EOD (end of day) price of the older series instrument and the EOD price of the newer series instrument. Again this may be the opposite, EOD newer less EOD older depending on whether the roll is spread based or price based. Thus the IG roll is the newer price minus the older price and the HY roll is the older price minus the newer price.

Thus, for switches an example is:

IG14 5Y/10Y indicative=(IG14 10Y indicative)−(IG14 5Y indicative)

and for rolls:

IG 13/14 indicative=(IG14 indicative)−(IG13 indicative)

The CDS price feed 20 will send the indicative price to the matching engine as a directed message. If the last traded price is available, that price is sent to the matching engine for dissemination to the price feed interface 40 and the front end 60. If the last traded price is not available, a price from the CDS pricing data source 30 is sent in its place.

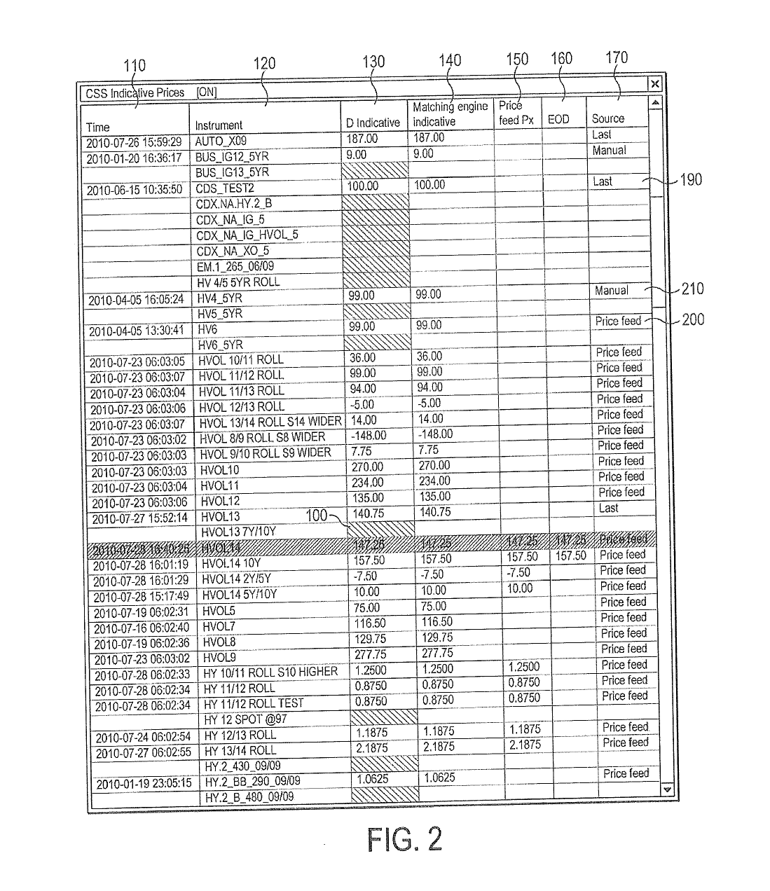

The interface 40 to the price feed is used by administrators to manage indicative prices provided by the price feed 20. Indicative prices are displayed in an indicative prices window and automatically refreshed by the system. An example of the indicative prices window is shown in FIG. 2. This window displays the indicative price for all instruments that can be traded on the window and shows the following information:

Time 100: The time of the last price update;

Instrument 120: The long name of the CDS instrument;

D Indicative 130: The current indicative price of the instrument in the price feed 20. If no price is available, the cell is highlighted, for example in red. An example of a highlighted cell is shown at 180 for instrument HVOL13 7Y/10Y. This means there is no spot Px assigned to this roll.

Matching Engine Indicative 140: This is the current indicative price available from the matching engine 10;

Price Feed 150: This is the indicative price retrieved from the CDS pricing source 30;

EOD 160: The price shown here is the last traded price of the previous trading day;

Source: This column indicates the source of the indicative price displayed in the D indicative column 130. The available sources include Last 190, which is the last traded price; Price feed 200 which is the indicative price provided by the pricing source 30; and Manual 210 which is a manual override price entered by the system administrator.

Indicative prices are sent from the matching engine 10 to the Credit Front End 60 by a broadcast message. The Credit Front End 60 uses the indicative prices to derive the default price for the passage manager (not shown) and for calculating price deviations. Indicative prices are used only if the following price sources are not available: Live orders from traders in the market; live prices in the market; or grey prices on screen.

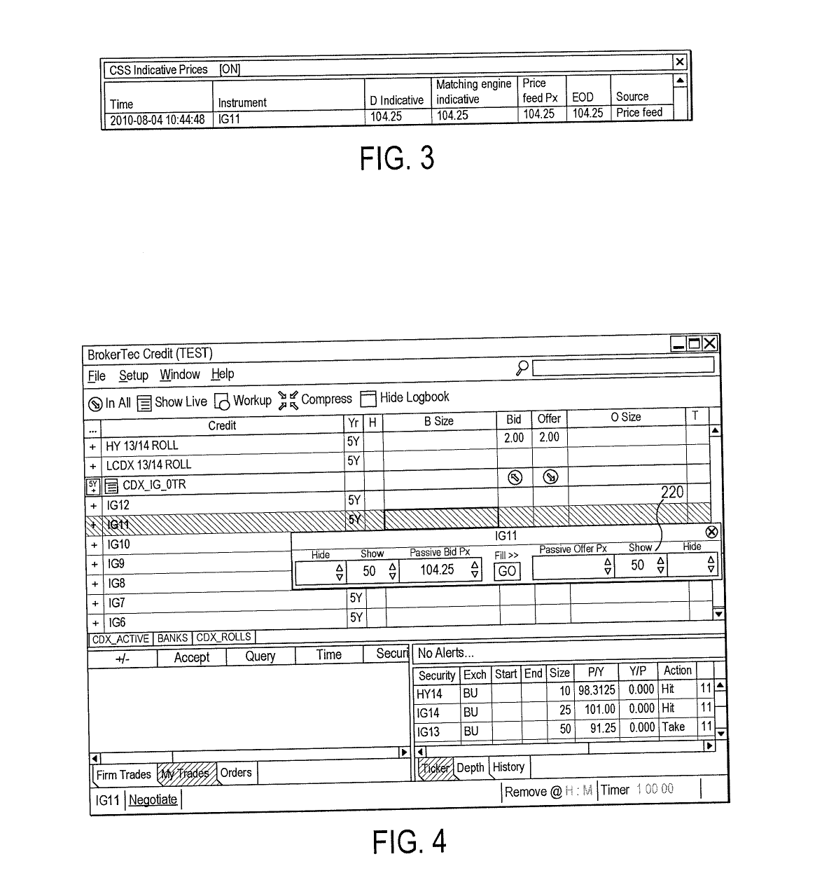

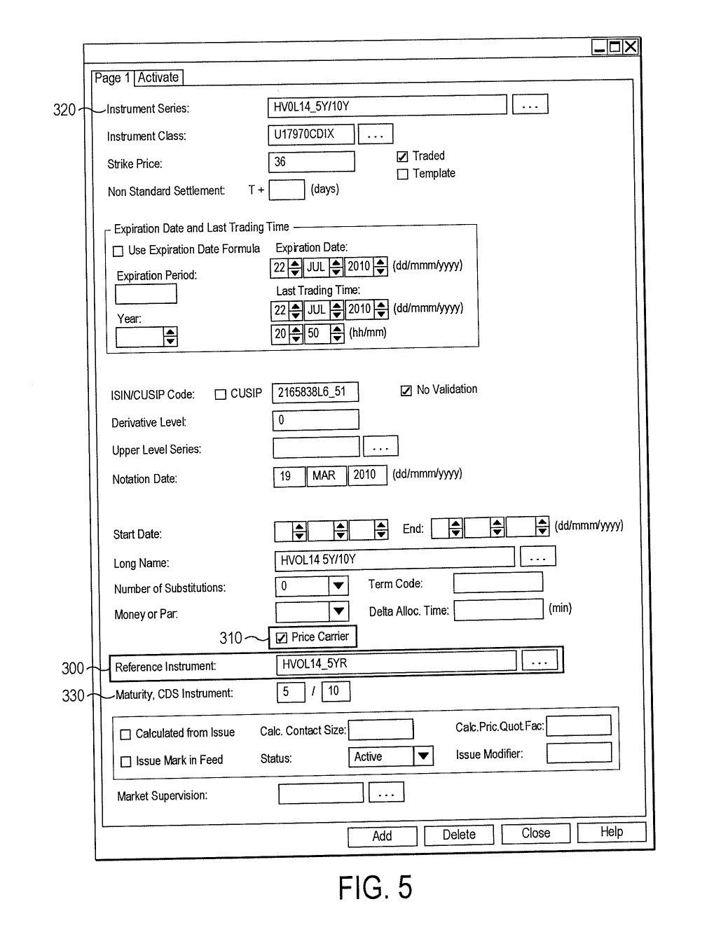

FIG. 3 shows a portion of the price feed interface 40 display of indicative prices for an instrument IG11. FIG. 4 shows the indicative price for this instrument as it appears in the Credit Front End passive manager. As can be seen from the left hand side of the display a number of series of IG instruments are shown each having a 5 year tenor. The IG 11 instrument is highlighted, by mousing over or clicking, opening an IG 11 panel 220 on the display. This displays the passive bid price in the system for a size of 50 and, in this case, shows no passive offer price in the system.

As well as displaying indicative prices, the system also provides spot prices in the credit front end which enables CDS combinations including rolls and tailor made switches to be performed. Indicative prices show the spread between two legs whereas the spot price is the price of one of those legs. Indicative prices are used in order management and appear when a trader invokes the passive order manager. Indicative prices may be displayed in a price entry window and in grey prices. Spot prices are displayed in the trader's user interface.

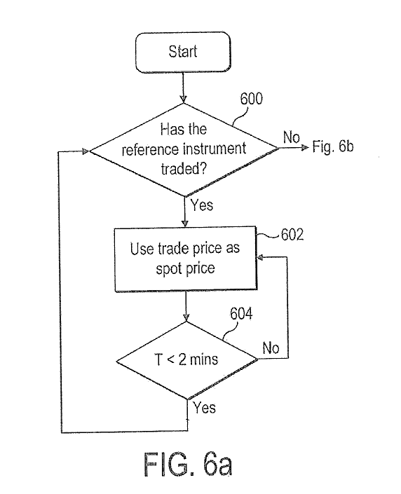

FIG. 5 shows an instrument series window that can be accessed via the database interface 50. For a CDS combination such as a roll or a switch to be performed, each combination must be linked to a reference instrument in order for the pricing feed to be able to determine its spot price. In FIG. 5, the reference instrument for a roll or the switch is defined in a reference instrument field 300. In FIG. 5 the reference instrument is HVOL 14-5YR. HVOL is a high volatility index. Here it is the 14^{th} issue and has a five year tenor. The instrument series window includes a price carrier box 310. If checked, the system validates that the instrument name specified in reference field 300 matches the short name of an existing instrument series. The switch shown in FIG. 5 is between five and ten year tenors as illustrated in the series name shown in field 320 and the maturity field 330. When a switch that contains a five year leg is created, the system may automatically insert the long name of the five year instrument in the reference instrument field 300.

The CDS price feed 20 calculates spot prices of combination instruments such as rolls and tailor made switches. The calculation is based on data from the following sources:

1. Trades—the price feed looks at the last traded price of the reference instrument. This is received as a broadcast message from the matching engine 10;

2. The external CDS pricing data source which provides an indicative price for the reference instrument;

3. Market prices. The best bid and offer prices in the market are broadcast from the matching engine 10. These prices are used to calculate a mid-price. Rules as discussed below may provide for calculation of a mid-price if the market is one-sided, that is there is either no best bid or best offer. For example, the mid-price may be defined as two ticks away from the side of the market that is available.

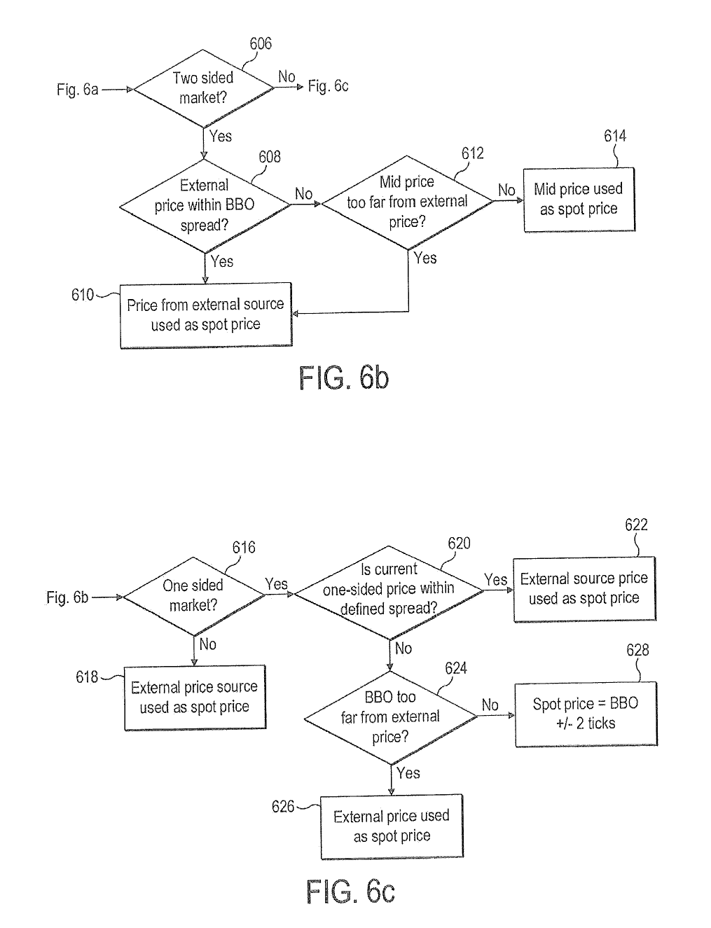

The rules used by the price feed for determining spot price are shown in FIGS. 6A to 6C.

The process gives greater weight to prices obtained from live trades. Thus, at step 600 in FIG. 6A, the system determines whether the reference instrument has traded. If it has, at 602 this price is used as the spot price. However, to avoid the price becoming stale, at 604, it is determined whether this price has been used for a predetermined and configurable time, here 2 minutes. If it is, the process reverts to step 600 to look for a more recent trade. In FIG. 6B the reference instrument has not traded and the system then determines at step 606 whether there is a two sided market. Again, in the absence of trades, the system is giving preference to live trading data from the system rather than external reference data. If a two sided market exists with both bids and offers in the system, the system determines at step 608 whether the price from the external source 30 is within the best bid/best offer (BBO) spread. If it is, the external price is used as the spot price at step 610. If it is not within the BBO spread, the system determines at step 612 whether the mid-price of the BBO is within a predetermined distance of the external price. This distance, for example 20 ticks, may be set and configured by the system administrator. If the mid-price is within this distance, then, at step 614, the mid-price is used as the spot price. If the mid-price is outside the distance, that is if it is too far from the external price, the system reverts to step 610 and uses the price from the external source 30 as the spot price.

In FIG. 6C, a two sided market does not exist and there have been no trades within the last predetermined time period. At step 616, the system determines whether there is a one sided market that is whether there are either bids or offers in the market. If neither are present, the system uses the indicative price from the external price source as the spot price at step 618. If a one sided market exists, at step 620 the system determines whether the current best bid or offer is within a predetermined spread with respect to the price from the external source. This spread may be, for example, 4 ticks or any other suitable amount and will depend on the instrument. If the spread is within this range the external price is used as the spot price at step 622. If the spread is outside this range, the system determines as step 624 whether the BBO is more than a predetermined and configurable number of ticks, for example 20, from the external source price. If the BBO is outside this number of ticks, the external price is again used as the spot price at step 626. However, if it is not outside the range, the spot price is set, at step 628 as the BBO plus or minus n ticks where n is a configurable number of ticks determined by the system administrator. In one preferred example, the spot price is the best bid plus 2 ticks or the best offer minus two ticks, dependent on which of the bid and offer is in the one sided market.

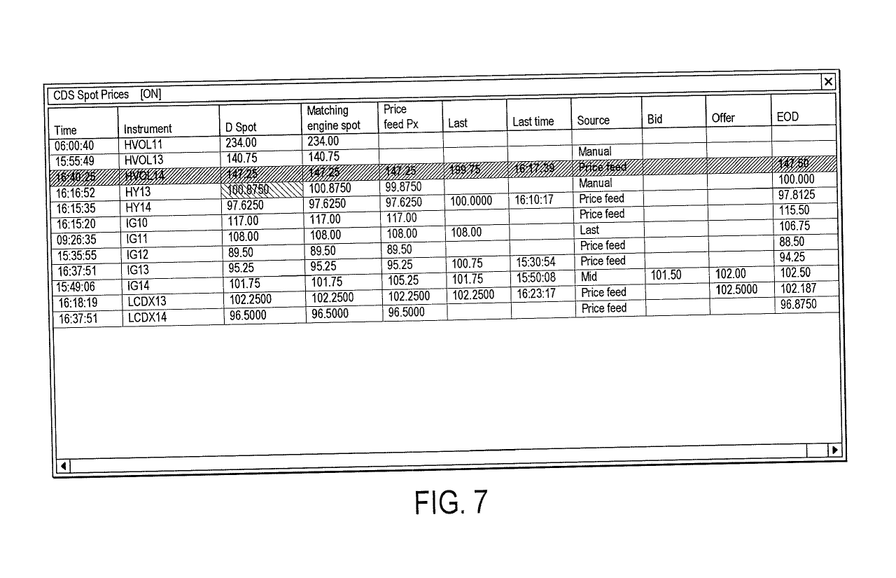

FIG. 7 shows the spot prices window that can be displayed in the price feed interface.

The display shows the spot prices of all the instruments that can be traded and shows the following information:

700 Time: of last price update;

710 Instrument: long name;

720 D spot: current spot price of reference instrument in price feed 20;

730 Matching Engine spot: current spot price of instrument in matching engine;

740 Price feed PX: the instrument price in the external price source 30;

740 Last: the last traded price;

760 Last time: the last trade time

770 Source: The source of the last traded price in the D spot column as determined using the algorithm of FIG. 6. In addition, a manual price may be inserted by the system administrator. Mid indicates mid-point 628; price feed indicates the external price source; and last indicates the last traded price 602;

772 Bid: current best bid price

774 Offer: current best offer price

776 EOD: the best trade price on the previous day.

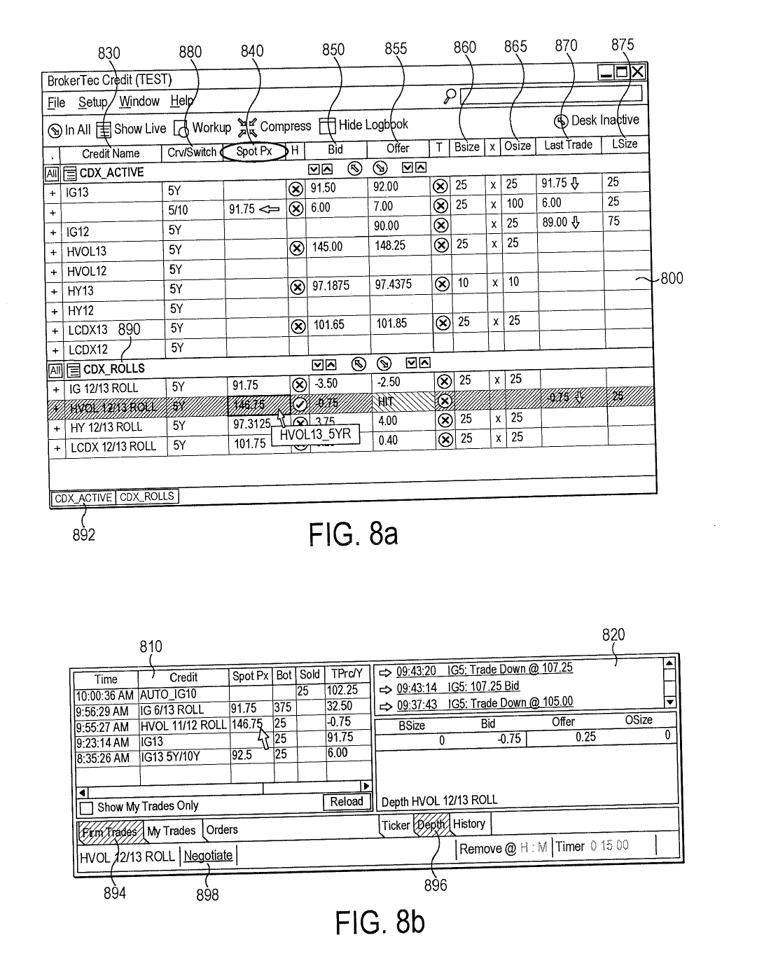

FIG. 8 shows how the spot prices are displayed to the user at the credit front end 60. This front end is the user, or broker's trading terminal. Thus, referring back to FIG. 1, the system comprises a plurality of Credit Front ends which communicate with the system in known manner, for example over a private communications network or via the Internet. The trading terminals may be arranged at trading floors of banks, brokers and other financial institutions and may be the front end of a more general trading system which allows trading across a range of instruments, for example a range of fixed income instruments. One example of such a system is the Assignee's BrokerTec® fixed income trading platform. The CDS trading system is one module on that platform that a broker or a trader can select from the many available for trading.

Referring to FIG. 8, the broker's display lists various Credit Default Swap Indices which can be traded. These are shown under the headings CDX_IG, CDX_HY and CDX_LCDX. These are only exemplary and other families of indices such as iTraxx may be traded. Within each family, various issues of different indices are available. Within the CDX_IG (where IG refers to Investment Grade), issues 13 and 14 of the IG index and the HVOL (High Volatility) indices are available. Within the CDX_HY (where HY refers to High Yield), issues 11 to 14 of the HY index are available. In the CDX_LCDX family, issues 12 to 14 of the HY index are available (LCDX refers to Loan Credit Default Swap).

It should be understood that all the products and instruments shown in FIG. 8 are credit default index products. However, the present invention is not limited to combination trades of such products such as rolls and switches but is also applicable to combination trades on single name credit default swaps (CDS).

In FIG. 8, the display is split into two parts. The upper part of the display, FIG. 8A shows a listing 800 of active instruments that are available for trading and the lower part of the display, FIG. 8B shows, on the left hand side, a panel 810 of trades that have been made on the system by the trader's firm and on the right hand side, a panel 820 showing the depth of the market in a selected roll. In FIG. 8A, the index name is listed in column 830. Column 840 is the spot price and column 850 and 855 are best bid and offer prices.

Columns 860 and 865 show the volumes available at the best bid and offer prices and columns 870 and 875 show the price and volume, respectively, of the last trade in the instrument. The Spot Px column is also shown in the Firm trades of FIG. 8b. Thus the system provides a record of the displayed spot price immediately following work up which is useful for transparency and reconciliation. The active trading display 800 is divided into two parts. The first, under the heading CDX_ACTIVE, shows ordinary trades and switches and the second, lower part, shows rolls. In the upper part switches are identified by having two tenors or maturities indicating that the price shown is a switch from one tenor to the other. Thus, the IG13 entry shows a 5 y to 10 year switch at an underlying price of 91.75 with a best bid of 6.00 and a best offer of 7.00. The remaining instruments in the upper part of the display are all indices having a 5 year tenor. The lower part of the display shows CDX rolls. Here, the name of the instrument identifies the roll. For example the first instrument is IG 12/13 Roll which rolls an issue 12 CDX IG product over to an issue 13 CDX IG product. The tenor of both legs of the roll is the same at 5 years, although this need not be the case. In the figure, the next roll is shown highlighted. This is achieved by the trader mousing over or clicking on the entry. The roll is HVOL 12/13 Roll and the effect of mousing over or clicking is to display the depth of the market for the roll in the bottom right hand panel 820. At the bottom of the upper part of the display tabs 892 identify the indices that can be displayed to the trader. In the present example only two are available but in practice, traders may have access to more indices that can be accommodated on the display and may choose to display only those in which they are actively interested. The display is thus customisable and traders can change the view to their liking.

Tabs 896 at the bottom of the panel 820 enable the trader to select what information is displayed. As alternatives to market depth, the trader may view a ticker or market history from that roll. The lower left hand panel is configurable via tabs 894 on the lower left hand side of the panel to enable traders to switch between views of trades made by their firm, by themselves or orders that are in the system but not yet filled. At the bottom of the screen, the roll that the trader has selected is identified and a link 898 marked ‘negotiate’ is provided, selection of which enables the trader to negotiate terms of a trade with a counterparty.

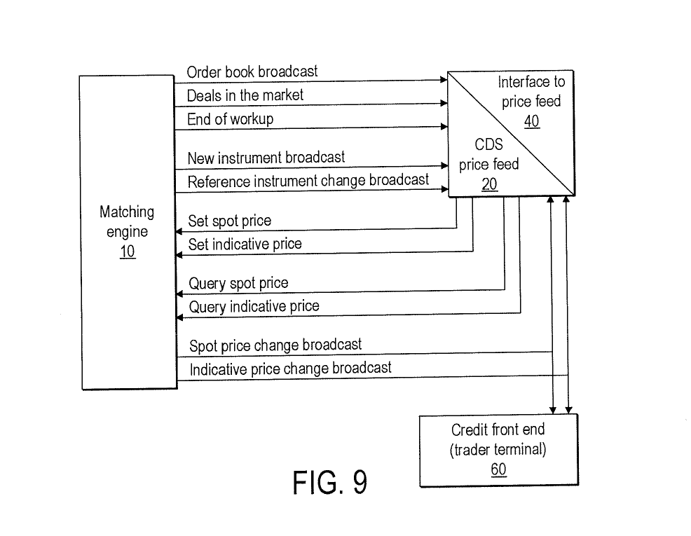

FIG. 9 illustrates key elements of the message flow in the system insofar as it relates to the provision of spot prices for rolls and switches. In the figure, all messages sent from the matching engine 10 are broadcast messages. Thus, the price feed 20 and the price feed interface 40 listen for broadcast messages which give best bid and offer and mid price information for instruments. As discussed above, this is necessary to enable the spot reference price to be determined in some circumstances. Similarly they receive the last traded price in the reference instrument for the same reason. An additional message informs the price feed and the interface when work up for a trade has ended. This enables the determination of spot price in the event that there has been a trade in the n previous minutes. In addition to broadcast information relating to existing instruments, the price feed 20 and the interface 40 also listen for information regarding new instruments, in particular the creation of a new instrument and a reference instrument change broadcast. The latter is necessary to determine which leg of a combination instrument is the price carrier, that is to which leg the reference price applies. Where an instrument is created for which a Spot Px carrier does not exist, but must be assigned, an alert is created in the indicative engine to ensure that the problem is identified by a market control function for remedy. The price feed sends price related directed messages to the matching engine, in particular, indicative and spot price messages. It also sends query spot price and query indicative price messages which are used to query previous day spot and indicative prices for all instruments at the start of the trading day. The prices returned by the matching engine are stored at the price feed 20. Finally, the matching engine broadcasts changes in the spot and indicative prices for all instruments to all credit front ends (trader workstations) and to the price feed and price feed interface. The price feed listens to these messages and updates its own internal prices database throughout the trading day. The price feed interface 40 uses these messages to update the spot price and indicative price windows.

The system and method described enable a reference spot price to be provided to enable a switch or roll to be performed. That reference spot price is displayed on the trader's screen next to the roll or switch instrument. The reference spot price is based on one of the legs of the combination. It is presently preferred that this reference is for a 5 year maturity as this a leg of the most common leg in all switches and rolls. However this need not be the case. The coupling of a reference price to each switch or roll instrument, and the method by which that reference price is calculated, as described above, enables switches and rolls to be performed on an electronic trading system. Moreover it gives traders confidence in the reference price that they are seeing and using, removing the need for protracted negotiation as to the correct reference price which has, in the past, been a key obstacle to the implementation of rolls and switches electronically. The system and method described increase the transparency of a transaction by displaying the spot or reference price, and also the hedge ratio, also known as the factor. The hedge ratio is a measure of risk derived from the dollar value of a basis point, known as dv01. CDS indices offer different maturities that carry different dv01 risk measurements. When performing combination or linked trades with indices of different maturities, in order to be market neutral, traders weight the legs against one another by dividing one dv01 value by another. This ratio is the factor or hedge ratio. The electronic system and method described simplifies an otherwise complicated and often contentious trade process bringing transparency to the market for all participants and regulators. This standardisation makes the platform safer and more user friendly. Additionally, traders will know exactly what to expect for the roll/switch trade outcome using the spot/reference price function and posted factors. To improve the transparency of the system further, a preferred embodiment may display the protocol used for a given roll or switch as the trader mouses over or clicks on an instrument or selects a ‘tool tip’ function. This further increases the transparency of the system. For example, where the instrument is a price switch, the trader may see the following text: ‘Buyer buys shorter maturity, sell dv01 of longer leg, trade size is on shorter maturity’.

Embodiments of the invention have the advantage that a standardised protocol for rolls and switches may be provided which can be used consistently in the market. In voice traded markets it has been acceptable practice to change the way in which components of a trade are quoted, for example the legs, spread quotes and whether or not a trade is dv01 weighted. This is not acceptable for a successful electronic system. As a result, indicative spreads can be generated as the system only allow a single way of quoting a particular type of roll or switch, even though different rules may apply to different types of rolls or switches. As an example, the following protocols may be used for certain commonly traded indexes:

IG Roll/Switches:

The Buyer of roll/switch is buying newer series/longer maturity and selling dv01 weighted shorter maturity/older series. The notional traded size will apply to the longer maturity/newer series (on-the-run).

### EXAMPLES

IG9/15 Roll—50 mm trades at 13 Spot=82 (IG15)

Bidder is buying 50 mm 15 s at 82, selling ˜127 mm 9 s at 69

Offer is selling 50 mm 15 s at 82, buying ˜127 mm 9 s at 69

Notional: Buyer bot 50 mm 15 s and sold DV01 9 s

IG14/15 Roll (50 mm trade)

Bidder is buying 15 s, selling 14 s

Offer is selling 15 s, buying 14 s

Notional: Buyer bot 50 mm 15 s and sold DV01 14 s

IG15 3/5 Switch (50 mm trade)

Bidder is buying 5 s, selling 3 s

Offer is selling 5 s, buying 3 s

Notional: Buyer bot 50 mm 5 s and sold DV01 3 s

IG15 5/7 Switch (50 mm trade)

Bidder is buying 7 s, selling 5 s

Offer is selling 7 s, buying 5 s

Notional: Buyer bot 50 mm 7 s and sold DV01 5 s

IG15 5/10 Switch (50 mm trade)

Bidder is buying 10 s, selling 5 s

Offer is selling 10 s, buying 5 s

Notional: Buyer bot 50 mm 10 s and sold DV01 5 s

Strike Price (Spot) shown on screen will always be on the on-run series for Rolls and 5 year maturity for Switches.

Rolls/Switches will trade in this manner regardless whether quoted positive or negative, therefore the legs will no longer change around on this platform.

HY Rolls & Switches

Since HY/LCDX trade in Price, those instruments will follow the reverse protocol of IG instruments:

The buyer of HY Roll/Switches will buy the shorter maturity/older series and selling longer maturity/newer series. The traded Notional size will apply to the shorter maturity/older series (off-the-run) and be dv01 weighted against longer leg.

### EXAMPLES

HY14/15 Roll—50 mm trades at 1.50

Bidder is buying 50 mm 14 s at 105.25, selling 48 mm 15 s at 103.75

Offer is selling 50 mm 14 s at 105.25, buying 48 mm 15 s at 103.75

Notional: Buyer bot 50 mm 14 s and sold DV01 15 s

HY15 3/5 Switch (50 mm trade)

Bidder is buying 3 s, selling 5 s

Offer is selling 3 s, buying 5 s

Notional: Buyer bot 50 mm 3 s and sold DV01 5 s

Strike Price (Spot) shown on screen will always represent the on-run series for Rolls and 5 year maturity for Switches.

In the embodiment described, the reference instrument is defined as part of the instrument series definition and becomes the price carrier. To ensure that the reference instrument exists in the system it is validated against existing instruments in the system.

A roll is a position change from one instrument to another where each has the same maturity. The reference instrument will therefore be present in the system. However, for a tailor made switch this is not necessarily the case as it is possible to define a switch having any maturity for either leg. For example, an IG13_{—}3 yr/4 yr switch assumes that both legs exist in the system but this may not be the case. As neither single term exists in the system it is not possible to assign automatically a price carrier to the switch. This may be overcome by using the spot pricing mechanism described only for common legs, such as the 5 yr maturity. If this maturity is not one of the two legs, there will be not reference instrument information for either leg and the spot price generation mechanism described cannot operate. However, in that case, it is open to the system administrator to inset a price manually.

It will be appreciated that more than one spot price may be displayed for a roll or switch as each instrument has a unique spot price assigned to it for each work up although this will depend on when live market data was available for each instrument. As explained above, once there is a live price in the market, the spot price is fixed for a period of time. This limits the number of participants who will agree on the same spot price. The system may permit traders to enter their own spot reference prices which reduces the risk of trading away if the market moves on the newest series while the spot price is locked. Many other modifications and developments to the embodiments described are possible and will occur to those skilled in the art without departing from the spirit and scope of the invention which is defined by the following claims.

1. A computerised trading system for trading credit default swaps combinations, comprising:
A matching engine storing data relating to credit default swaps available for trading and data relating to the reference instruments on which the credit default swaps are based;
A price feed for generating a spot reference price for credit default swap combinations, the spot reference price being the spot reference price of one leg of the combination;
Wherein the price feed is operable to receive pricing data for generation of the spot reference price from a pricing source external to the computerised trading system and from the matching engine.

2. A computerised trading system according to claim 1, wherein the pricing data received from the matching engine is the last traded price of the reference instrument.

3. A computerised trading system according to claim 3, wherein the price feed generates the spot reference price for the credit default swap combination from the last traded price of the reference instrument if the last trade in the reference instrument occurred within a predetermined period of time.

4. A computerised trading system according to claim 1, wherein the pricing data received from the matching engine is at least one of the current best bid and offer for the reference instrument.

5. A computerised trading system according to claim 1, wherein the pricing data received from the external pricing source is indicative pricing data.

6. A computerised trading system according to claim 5, wherein the price feed generates the spot reference price from the pricing data received from the external pricing source if a best bid and best offer price are available from the matching engine and the best bid best offer spread is within a predetermined range.

7. A computerised trading system according to claim 5, wherein the price feed generates the spot reference price from the pricing data received from the external pricing source if only one of a best bid and best offer price is available from the matching engine and the best bid best bid or offer is within a predetermined distance of the price from the external pricing source.

8. A computerised trading system according to claim 5, wherein the price feed generates the spot reference price from the pricing data received from the external pricing source if the matching engine indicates that there are no orders in the market for the reference instrument.

9. A computerised trading system according to claim 4, wherein the price feed receives current best bid and best offer data for the reference instrument from the matching engine, the price feed being configured to generate a reference spot price from the mid point of the best bid and best offer if the mid price is greater than a predetermined distance from the indicative price received from the external pricing source.

10. A computerised trading system according to claim 4, wherein only the best bid price is received by the price feed from the matching engine and the price feed is configured to generate the spot reference price from the best bid price minus a predetermined number of price ticks.

11. A computerised trading system according to claim 4, wherein only the best offer price is received by the price feed from the matching engine and the price feed is configured to generate the spot reference price from the best offer price plus a predetermined number of price ticks.

12. A computerised trading system according to claim 1, wherein the credit default swap combinations are rolls.

13. A computerised trading system according to claim 1, wherein the credit default swap combinations are switches.

14. A computerised trading system according to claim 1, wherein the credit default swaps are single name instruments.

15. A computerised trading system according to claim 1, wherein the credit default swaps are index instruments.

16. A computerised trading system according to claim 1, wherein the price feed is configured to send generated reference prices to the matching engine.

17. A computerised trading system according to claim 16, comprising a plurality of trader terminals each including a display of credit default swap combinations available for trading, the display including the spot reference price for a leg of each combination generated by the price feed and broadcast to the trader terminals by the matching engine.

18. A price feed for a computerised trading system for trading credit default swap combinations, the trading system having a matching engine for matching bids and offers to perform trades, the price feed being configured to receive indicative pricing data for a reference instrument of a leg of the combination from a pricing source external to the trading system, and to receive market data relating to the reference instrument from the matching engine including trade prices and best bid and best offer prices, and wherein the price feed is further configured to generate a reference spot price of a leg of the combination from the trade prices, the best bid and best offer prices and the external indicative prices.

19. A computerised method for trading credit default swap combinations on a computerised trading system trading the reference instrument underlying the swap combination, the trading system comprising a matching engine and a price feed, wherein the method comprises:
the price feed generating a spot reference price for the credit default swap combination, wherein the spot reference price is at least partially generated from a source of pricing of the reference instrument external to the trading system; and
distributing the generated reference prices to trader terminals communicating with the trading system together with further data relating to the credit default swap combination.

20. A computerised method according to claim 19, wherein the further data relating to the credit default swap combination comprises the instrument to be traded, and bid and offer prices.

21. A computerised method according to claim 20, wherein the further data comprises the price and volume of the last trade in the combination.

22. A computerised trading method according to claim 19, wherein the price feed generates the spot reference price at least partially based on the last trade price data for the reference instrument traded on the trading system and sent to the price feed from the matching engine.

23. A computerised trading method according to claim 22, wherein the price feed generates the spot reference price for the credit default swap combination from the last traded price of the reference instrument received from the matching engine if the last trade in the reference instrument occurred within a predetermined period of time.

24. A computerised trading method according to claim 19, wherein matching engine sends at least one of a current best bid and offer in the trading system for the reference instrument.

25. A computerised trading method according to claim 19 wherein the pricing data received from the external pricing source is indicative pricing data.

26. A computerised trading method according to claim 25, comprising the price feed generating the spot reference price from the pricing data received from the external pricing source if a best bid and best offer price are available from the matching engine and the best bid best offer spread is within a predetermined range.

27. A computerised trading method according to claim 25, comprising the price feed generating the spot reference price from the pricing data received from the external pricing source if only one of a best bid and best offer price is available from the matching engine and the best bid best bid or offer is within a predetermined distance of the price from the external pricing source.

28. A computerised trading method according to claim 25, comprising the price feed generating the spot reference price from the pricing data received from the external pricing source if the matching engine indicates that there are no orders in the market for the reference instrument.

29. A computerised trading method according to claim 24, comprising the price feed receiving current best bid and best offer data for the reference instrument from the matching engine, the price feed being configured to generate a reference spot price from the mid point of the best bid and best offer if the mid price is greater than a predetermined distance from the indicative price received from the external pricing source.

30. A computerised trading method according to claim 24, comprising the price feed receiving a best bid price and no best offer from the matching engine, and the price feed is configured to generate the spot reference price from the best bid price minus a predetermined number of price ticks.

31. A computerised trading system according to claim 24, comprising the price feed receiving a best offer price and no best bid price from the matching engine and the price feed is configured to generate the spot reference price from the best offer price plus a predetermined number of price ticks.

32. A computerised trading method according to claim 19, wherein the credit default swap combinations are rolls.

33. A computerised trading method according to claim 19, wherein the credit default swap combinations are switches.

34. A computerised trading method according to claim 19, wherein the credit default swaps are single name instruments.

35. A computerised trading method according to claim 19, wherein the credit default swaps are index instruments.

36. A computerised trading method according to claim 19, comprising sending generated reference prices from the price feed to the matching engine.

37. A computerised trading method according to claim 36, comprising displaying of credit default swap combinations available for trading a the display of trader terminals communicating with the trading system, the display including the spot reference price for a leg of each combination generated by the price feed and broadcast to the trader terminals by the matching engine.

38. A computerised trading system for trading credit default swaps rolls and switches, comprising:
A matching engine storing data relating to credit default swaps rolls and/or switches available for trading and data relating to the reference instruments on which the credit default swaps are based;
A price feed for generating a spot reference price for credit default swap rolls and/or switches, the spot reference price being the spot reference price of one leg of the roll or switch;
Wherein the price feed is operable to receive pricing data for generation of the spot reference price from a pricing source external to the computerised trading system and from the matching engine.
